(19) United States
(12) Patent Application Publication
(10) Pub. No.: US 2024/0099292 A1
(43) Pub. Date: Mar. 28, 2024

(54) Modular Insect Barrier Device

(71) Applicants: Zachary Kops, Aspen, CO (US); Edward Tarnell, Aspen, CO (US)

(72) Inventors: Zachary Kops, Aspen, CO (US); Edward Tarnell, Aspen, CO (US)

(21) Appl. No.: 18/477,486

(22) Filed: Sep. 28, 2023

Related U.S. Application Data
(60) Provisional application No. 63/410,726, filed on Sep. 28, 2022.

(51) Int. Cl. A01M 29/34; A01M 1/14

(52) U.S. Cl. CPC A01M 29/34; A01M 1/14

(57) ABSTRACT

A modular insect barrier device is disclosed within which forms a protective barrier over an insect-attracting adhesive in order to prevent by-catch. Various embodiments of the invention may be configured for preferred purposes, including but not limited to ease and economy of manufacture; a more complete barrier against insect encroachment; optional incorporation of a flexible wrap which yet further protects the tree while supporting the linked chain of the modular insect barrier device; and, to allow for user-customizable design by the exchange of one configuration of links for another or incorporation of adornments to the structure herein.

### CROSS-REFERENCE TO RELATED APPLICATIONS

This application claims benefit under 35 U.S.C. § 119(e) to the provisional patent application filed Sep. 28, 2023, bearing the Application No. 63/410,726.

### BACKGROUND OF THE INVENTION

Invasive species pose a serious threat to native flora and fauna. With no natural predators or defenses against their expansion, these invasive species can devastate ecosystems and the economies that depend upon native plant and animal life. One prominent example is the spotted lanternfly, an insect native to China and Southeast Asia which feeds primarily upon hardwood trees. This species has invaded the eastern United States, damaging ecosystems in the region since at least as early as 2014. Aside from ecological impact, these pests cause economic losses ranging in the millions of dollars each year.

Currently, there is no method for eradicating this species which is both effective and safe for the native fauna. However, mitigating measures have been found effective. Lanternflies are poor fliers, preferring to climb trees rather than perch on them, only to glide downward when ready to move on. Because of this peculiarity of the species, tree tape with an outer, adhesive edge has been found to be effective for trapping these insects as they crawl up the trunks of hardwood trees. Unfortunately, these trapped insects attract birds, mammals, and other insect-eating species, which can become trapped in the same tape, a hazard known as “by-catch.” Such by-catch does unintended collateral harm to the local ecosystems; moreover, by-catch can discourage the use of effective adhesive bands in urban and suburban environments where the sight of a trapped bird or mammal may be distressing to locals. It is desirable to have method for trapping insects which does not also trap or harm those animals which prey upon them and other harmful insects, which is unobtrusive, cost-effective, and modular, and which is easily replaceable as the adhesive trap becomes saturated with insects or loses its adhesive properties over time.

Various prior art solutions to the problem of tape protection have suffered from a number of limitations. Designs such as that presented by Carman, U.S. Pat. No. 6,230,435, are of unitary construction and must be made to size, being consequently usable only for a particular tree at one point in its life cycle, as well as requiring complete replacement if broken. Other designs must be made to incorporate a flexible component, such as the collection sack presented by Bergey, U.S. Pub. No. 2021/0045297, which may be easily damaged by high winds and inclement weather. The prior art generally cannot be easily manufactured with inexpensive or modular equipment, as a unitary ring is claimed in the prior art as in Carman and Bergey, as well as in Gerendas, U.S. Pat. No. 2,261,360, and Hubbell, U.S. Reg. No. 691,546. Such unitary pieces must be replaced if damaged and by their nature as unitary design must be constructed of weaker, flexible materials in order to wrap around a tree, a limitation not shared by a modular design which may comprise more robust pieces. Such robust pieces may better withstand inclement weather, the interference of larger animals, or adornment with additional user-made modifications. Invasive species can spread rapidly; any limitation on the design of the countermeasures enables the problem of invasive species spread to grow. A need exists for a design which does not have these substantial limitations.

Certain prior art solutions further incorporate a flexible wrap encircling a targeted tree an incorporating insect-trapping adhesives. However, the flexible wraps so disclosed cannot prevent by-catch or mitigate the effects of weather upon the adhesive. Configuration of such flexible wraps to accept the present invention yields complementary results.

The present invention circumvents these limitations with its unique shape and modular, sturdy design; the invention can be constructed in varying embodiments to fit a variety of trees and with a variety of features as disclosed while remaining within the scope set forth herein.

### SUMMARY OF THE INVENTION

The device presented herein is a modular insect barrier device. The device is foremost a solution to the problem of by-catch, designed to enable the continued use of tree-tape to catch spotted lanternflies and other invasive insects while minimizing the risk to birds and other helpful predators. The device must be useable on trees of a variety of shapes and sizes. It is desirable that the device be low-cost and easily manufactured for use on a wide scale. It is further desirable for the device to be simple enough to be deployed by users without expert assistance. It is further desirable for the device to be of robust construction in order to withstand any foreseeable weather conditions. It is further desirable that the device can be readily made unobtrusive to encourage urban and suburban use. It is further desirable that the invention be modular to allow customization for a variety of tree shapes and for a variety of birds and mammals to exclude from the tree-tape.

The device presented herein solves these problems through its modular design. The device is designed to act as part of a chain of similar or identical devices, with each such device joining or abutting with others to form a chain configured as a barrier of variable size around the trunk of a selected tree. This chain or barrier is positioned to cover and protect one or more strips of insect-trapping tape which allows access to crawling and flying insects but prevents access by birds or insect-eating mammals. The chain is configured to be attachable to a tree in a variety of ways to account for the unique shape and sizes of each individual tree. The “chain” design further allows the barrier to be expanded as the tree grows. The chain design even enhances the reusability of the device, as individual links may be replaced or re-used elsewhere.

Each link in the chain is configured to be joinable or abuttable on at least two sides to similar links. The links themselves vary in their embodiments, with the usable variants limited only by the practicalities of size and by the need to interconnect or otherwise mate with other links in the same chain. Indeed, various additional embodiments of the joinable sides may be apparent to one skilled in the art upon review of this disclosure, so long as the joinable sides are used with other links connected to one another. Such embodiments are intended to be included and claimed within the scope of the claims and disclosures herein.

Certain embodiments of the individual links in the chain may have a solid or slotted surface. The solid surface offers the greatest reduction in by-catch and further allows users to camouflage the chain with a pleasing or unobtrusive design, complemented by the low-profile shape of certain embodiments described herein. This design encourages urban and suburban use where insect-trapping tape might otherwise be deemed unsightly, thereby enabling the invasive species control measures to be employed on a wider scale. Other embodiments may comprise a slotted surface, reducing the weight and materials cost of the links and the chain; this slotted appearance further may reduce by-catch without inhibiting the use of insect-attracting colored adhesive traps.

Various embodiments of the links are disclosed herein to account for the varying needs of the user. Other embodiments may be apparent to one skilled in the art upon review of this disclosure. Such embodiments are intended to be included within the scope of the claims herein.

Insect-trapping adhesives are available in various configurations on the market. The insect-trapping adhesive, by itself, is not a claimed feature of this invention; this invention is intended for the protection of such insect-trapping adhesives. This invention may be deployed according to the method disclosed within for the encirclement of a targeted tree with or without an insect-trapping adhesive, but are preferably deployed as described to enclose a length of insect-trapping adhesive.

### BRIEF DESCRIPTION OF DRAWINGS

The drawings included herein are illustrative of certain embodiments of the invention. Additional embodiments are set forth in this disclosure.

FIG. 1 is a perspective view of a single link in the preferred embodiment; the outer surface, sidewall, and endcap can be seen to partially enclose a space in the approximate shape of a truncated triangular prism.

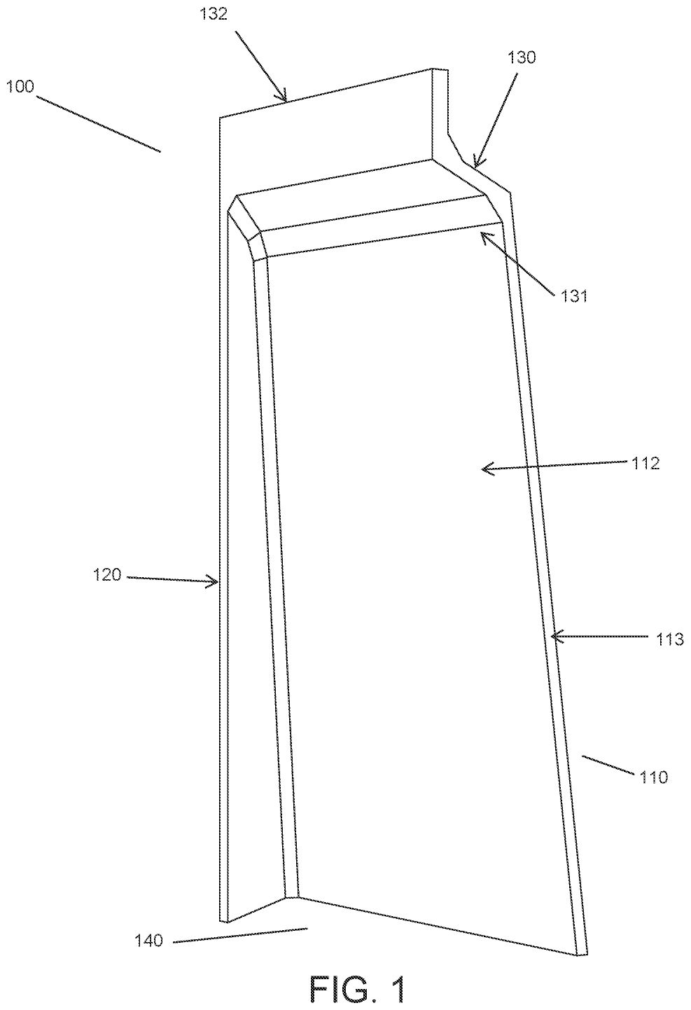

FIG. 2 is another perspective of the link pictured in FIG. 1, this perspective being that facing the inner surface of the link through the partially enclosed space.

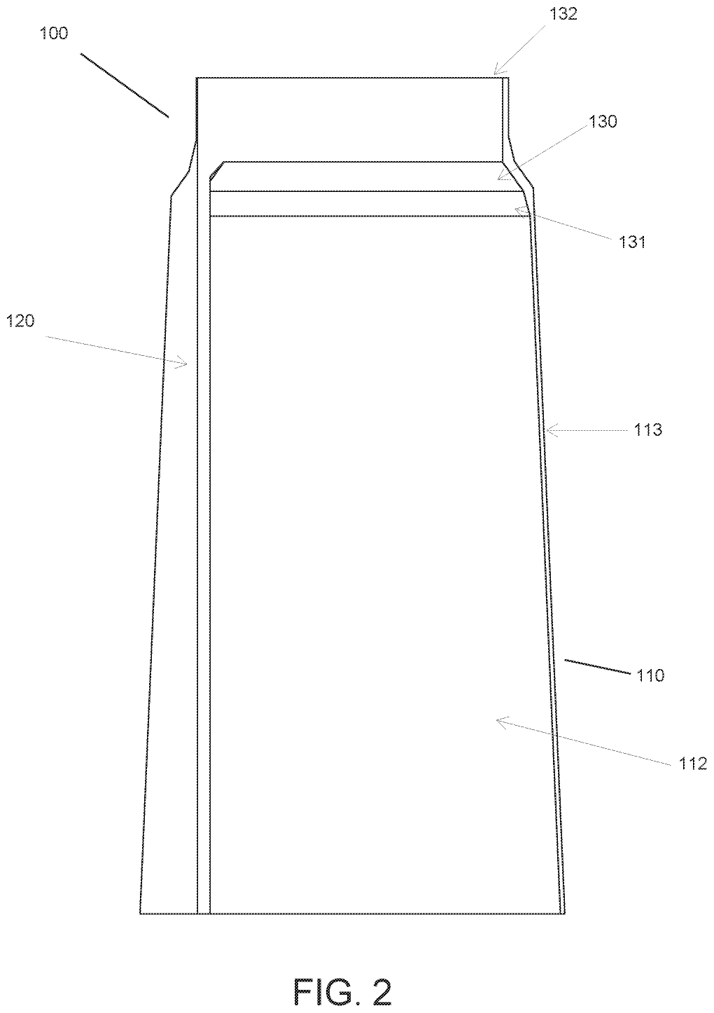

FIG. 3 is a side view perspective view of the link pictured in FIG. 1, from the side opposite the sidewall.

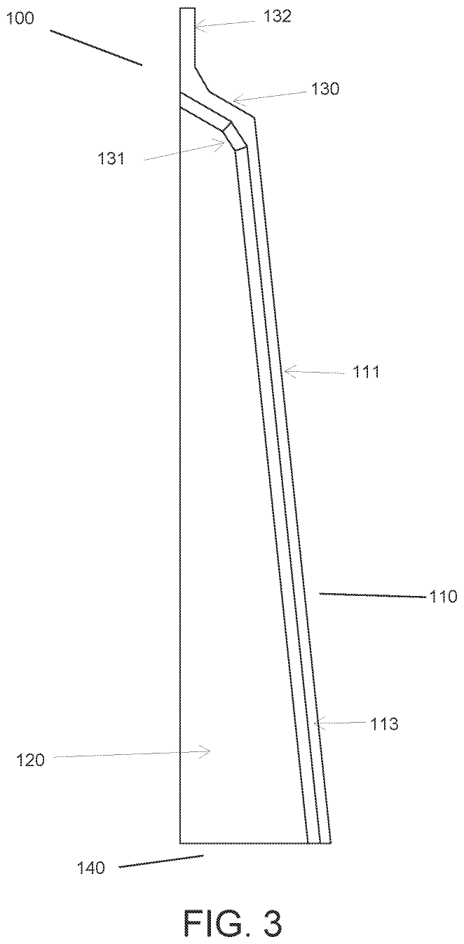

FIG. 4 is an alternate embodiment comprising feet joined to the sidewalls as described below, being configured such that these feet may accept joining means to the tree or to the flexible wrap disclosed herein by joining means which may comprise, in certain alternate embodiments, hook and loop fasteners or adhesives.

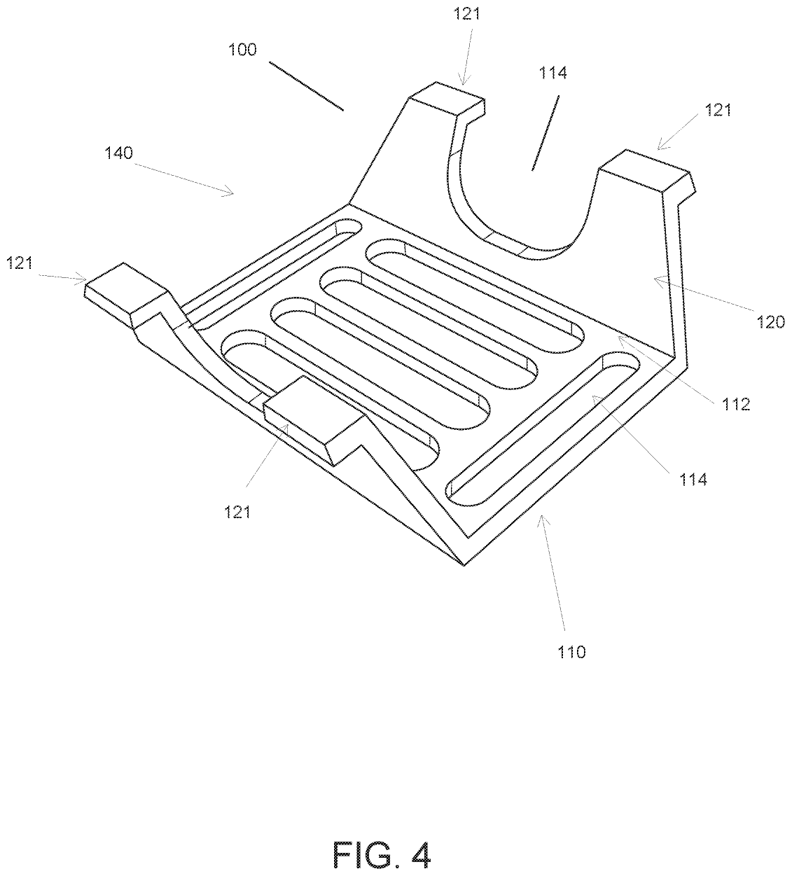

FIG. 5 is a perspective view of a further-simplified embodiment of the present invention, lacking the chamfered connecting angle and endcap tab of the preferred embodiment.

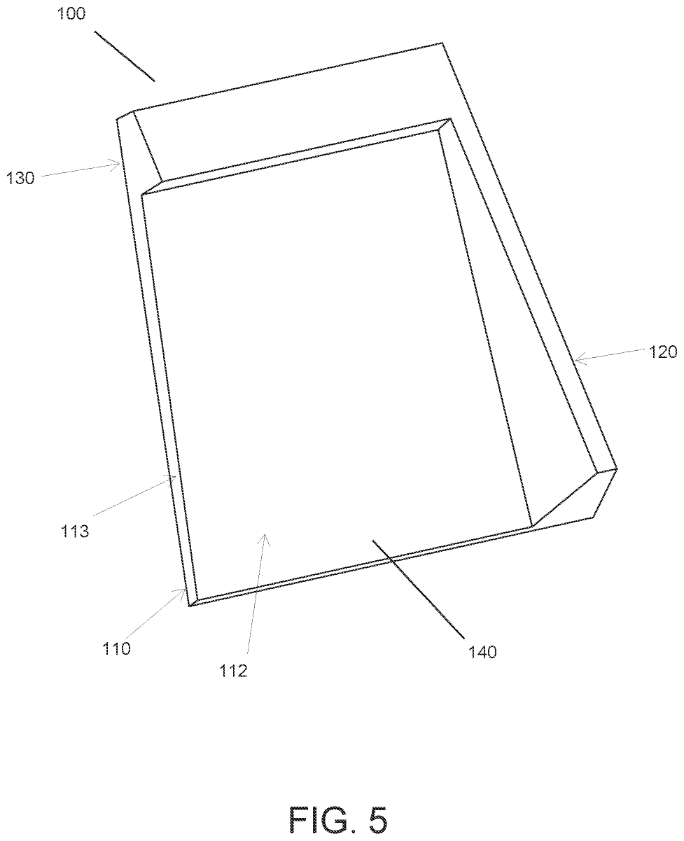

FIG. 6 is an alternate embodiment in which cutouts are present on the outer shell.

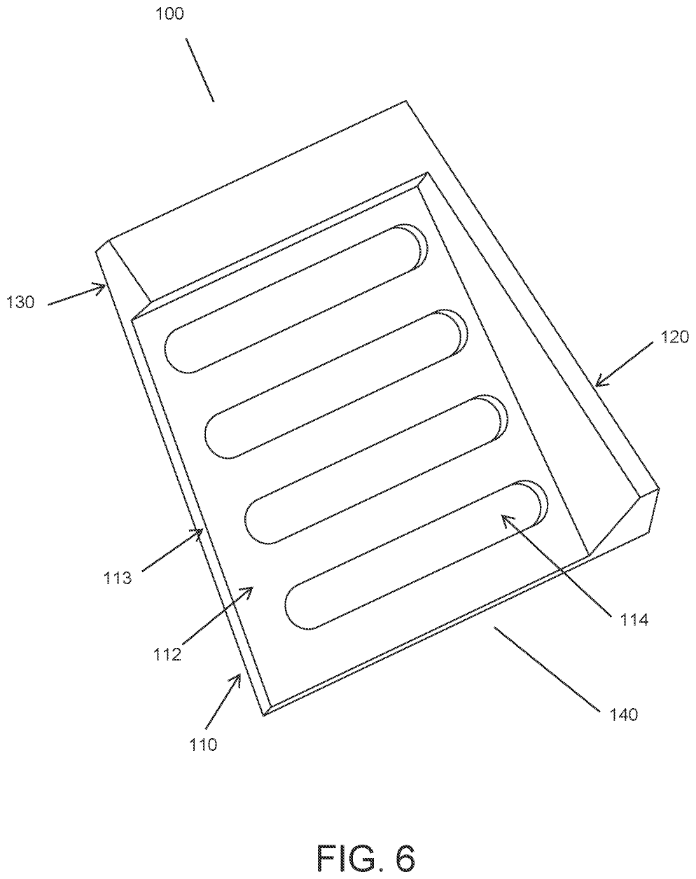

### DETAILED DESCRIPTION OF THE INVENTION

The description set forth herein, in connection with the drawings, is intended to illustrate the claimed subject matter through its preferred embodiments and is not intended to represent the only embodiments in which the invention can be configured or utilized. Other embodiments may be apparent to one skilled in the art in light of this disclosure.

When the verb “join” is used herein to refer to elements of the present invention, including adjective and other forms such as “joinable”, it is understood the term includes all disclosed embodiments and methods by which individual components in the described plurality may be fastened together; this includes but is not limited to interlinking pieces, joining by adhesives, joining by fasteners, and joining by force of friction. Other means of joining pieces will be apparent to one skilled in the art upon review of this disclosure. Certain embodiments of the present invention may lack “joinable” edges in this sense of the term, but nevertheless comprise contactable, geometrically-coincident edges intended to fit together in such embodiments' deployed configurations, being configured to remain in the position deployed by means other than joining of these abuttable components, such as fixing these components directly to a targeted tree or other object or member; the term “abutted” or “abuttable” and variants will be used herein for this purpose as distinct from “joined” or “joinable” elements.

In its most basic embodiment, the present invention comprises a plurality of links 100, each link 100 further comprising an outer shell 110, at least one sidewall 120 fixed to or unitary with the outer shell 110, and an endcap 130 fixed to or unitary with the outer shell 110; the outer shell 110, at least one sidewall 120, and endcap 130 are configured to partially enclose a volume of space in the approximate shape of a triangular prism or truncated triangular prism, resulting in an entryway 140 opposite the endcap. In this most basic embodiment, the at least one sidewall 120 is configured to a lengthened triangular shape tapering toward the endcap 130 and widening further away from the endcap 130.

The outer shell 110 in this preferred embodiment comprises a single, flat, unitary rectangular surface. In this embodiment, an outward-facing surface 111 of the outer shell may be configured to accept adornments or paints for purposes of camouflage or decoration. An inward-facing surface 112 of the outer shell may be further configured to accept insect-trapping adhesives or insect-attracting bait.

The preferred embodiment comprises a single sidewall 120; an opposite edge 113 of the outer shell 110 is preferably left unadorned. Further, in this preferred embodiment, the endcap 130 further comprises a distal flange 131. The sidewall 120 is fixed to or unitary with the outer shell 110 at an angle such, when rested on a surface, that the sidewall 120 and endcap 130 will elevate the outer shell 110 at an uneven angle, resulting in the entryway 140 opposite the endcap 130 of a size determined by the dimensions and angle of the sidewall 120. This angle may be ninety degrees, as measured from the sidewall 120 to the outer shell 110 through the volume of enclosed space, or even greater than ninety degrees up to one-hundred fifty degrees; however, the preferred embodiment comprises an angle less than or equal to ninety degrees. This preferred acute angle biases the links 100 to configurability in a circular shape when deployed abutted or joined to one another as described herein, forming a chain 200; other angles may be preferable for a targeted tree of varying sizes and shape. Other embodiments configured for ease of manufacture and transport may be configured such that this angle is obtuse, allowing for multiple links 100 to be stacked easily for transport.

In the preferred embodiment, the endcap 130 and outer shell 110 are of unitary construction and distinguished by a chamfered connecting angle 131 and an endcap tab 132. This preferred embodiment comprises construction of resin or plastic by injection molding. However, this preferred embodiment is configured to be easily produced by a three-dimensional (“3D”) printer; this embodiment enables the invention to be marketed and deployed not only as pre-made links, but as licensed electronic files. Other embodiments may comprise other materials such as steel, aluminum, or plastic. Embodiments of any kind are not restricted in color.

When deployed, each link 100 is joined to others to form the chain 200. In the preferred embodiment, the sidewall 120 of a first link 100 is abuttable to a matching opposite edge 113 of the outer shell 110 of a second link 100. Other embodiments of the link 100 may comprise a sidewall 120 of a first link 110 joinable to an opposite edge 113 of a second link 100; in embodiments comprising such joinable elements, the joinable elements may join by action of added geometrically interconnecting flanges, fasteners, adhesives, or by other means which will be apparent to one skilled in the art in light of this disclosure. Yet further embodiments of the link 100 may comprise two sidewalls 120, with the second sidewall 120 fixed to or unitary with the outer shell 110 to further enclose the enclosed space enclosed by the outer shell 110 and first sidewall 120; in this embodiment, a first sidewall 120 of the first link 100 is joinable to or abuttable to a second sidewall 120 of the second link 100. In an embodiment comprising two sidewalls 120, it is preferred that the sidewalls 120 be configured with inward angles. In such embodiments, the chain 200 may form a complete barrier to advancing insects; for example, a chain 200 comprising eight links 100 in which each sidewall 120 is offset forty-five degrees inward will form a complete circle when said links 100 are abutted sidewall 120 to opposite edge 113 as described.

Joinable embodiments of the present invention may be suspended about the trunk or a limb of the targeted tree as described within by geometry and friction alone, with the radius of the chain 200 being equal to that of a selected segment of a targeted tree while being less than that of the segment immediately below said selected segment of a targeted tree. Other embodiments may be suspended from the tree by means of adhesives, or by fixing to a rope, wrap, or other flexible material encircling the targeted tree, or by means of fixing members such as bolts, screws, nails, or tacks, or by any other means known to the art. By such means the links 100 may be joined, or the links 100 may be abutted to one another while fixed to the targeted tree.

In all embodiments, the endcap 130 of each link 100 is configured for positioning in the same direction as that of every other link 100, resulting in the entryway 140 being configured in the same direction for the entire assembled chain 200; for those crawling, hardwood tree parasite insects which are the preferred target of this embodiment, the endcap 130 is deployed upward and most distant from the ground, while the entryway 140 is deployed downward to enable capture of crawling insects as they ascend the trunk of the protected tree. The chain 200 is deployed around the targeted tree, preferably so as to protect an insect-trapping adhesive fixed to said tree. So deployed, the chain 200 covers the insect-trapping adhesive in such a manner as to prevent easy access by birds and mammals. It is preferred that the chain 200 be deployed horizontally around the trunk of a targeted tree; however, the chain may be deployed diagonally to avoid protrusions in the targeted tree such as the stump of a lost limb, or the chain 200 may be deployed around the limbs of a targeted tree.

The overall length of each link 100 from the endcap 130 to the entryway 140 may vary according to its intended use. A shorter link 100 is lighter, less expensive, and easier to place, particularly on any tree not regular in shape or size; a longer link 100 may be made more robust, subject to construction materials; if configured in an embodiment of sufficient length, the links 100 may be deployed to cover a larger segment, or a plurality of segments, of insect-trapping adhesive. Such a configuration allows each segment of insect-trapping adhesive to remain deployed for a longer period of time before becoming saturated with trapped insects and requiring replacement, particularly in locations with denser swarms of insects.

Any link 100 may be decoupled from the chain 200 for replacement and disposal or re-use, thereby enabling reconfiguration of the chain 200 by addition or subtraction of links 100. This modularity enables the chain 200 to protect the targeted tree as it grows or as it sheds and regrows bark, or as individual links 100 become damaged or it is otherwise desirable to replace said links 100.

A method is described in which a plurality of links 100 are deployed for the protection of an insect-trapping adhesive affixed to a selected tree. In this method, as a first step, a user selects an appropriate quantity and size of links 100 to encircle a selected section of a targeted tree. As a second step, the user fixes the plurality of selected links 100 around the tree in succession, beginning with a first link 100, joining or abutting the appropriate sidewalls 120 and opposite edges 113 of each successive link 100 in the same fashion, then in a third step finally joining or abutting a final sidewall 120 or final opposite edge 113 of a final link 100 to the corresponding sidewall 120 or the corresponding opposite edge 113 of the first link 100 to completely encircle the tree with the chain 200. In an alternate method, a step in which the user joins a plurality of selected links 100, omitting only the act of joining one or more links 100, is performed between the second and third step of the preferred method, such that one or more chains 200 smaller than the final chain 200 are formed, which are then fixed to the targeted tree, joining those links 100 not yet joined as described in the preferred method until the final link 100 is joined to the first link 100 to completely encircle the tree as in the third step of the preferred method, forming the final chain 200.

Alternate embodiments of the present invention may further comprise cutouts 114 comprising holes of varying shapes set in the elements of one or more links 100 in the chain 200. Such cutouts 114 may be present in any element of a link 100, including the outer shell 110, sidewall 120, endcap 130, or in variations of these elements including the distal flange 131. Such cutouts 114 are desirable in embodiments in which weight or materials cost of the links 100 incorporating such cutouts 114 must be reduced or access must be permitted within the space partially enclosed by the sidewall 120 outer shell 110, and endcap 130.

In an alternate embodiment, a link 100 may comprise two sidewalls 120; in this alternative embodiment, each sidewall 120 may be configured to further comprise one or more feet 121. Such feet 121 fixed to a first link 100 may be further configured to be joinable to or abuttable to feet 121 fixed to a second link 100. Such feet 121 further comprise a joining means 122, preferably a first side of a hook-and-loop fastener. In this embodiment, insect-trapping adhesive is preferably applied to a length of flexible wrapping material 300. This embodiment may further reduce or omit the endcap 130 to reduce weight and material costs, the endcap instead being a second entryway 140. Further arched cutouts 114 set into the sidewalls 120 may further permit this embodiment of the link 100 to be configured for various configurations of joining means 122.

The flexible wrapping material 300 comprises one or more layers of material 310, and further comprises a corresponding joining means 322, preferably a corresponding side of a hook-and-loop fastener, configured to other joining means 122 on the feet 121. Preferably, the flexible wrapping material 300 is constructed with an inner surface 311 configured for encircling the targeted tree, as well as an outer surface 312 comprising three parallel sections 330, said three parallel sections comprising a trapping space 331 configured to accept application of the insect-trapping adhesive, an upper parallel section 332 further comprising a corresponding joining means 322, and a lower parallel section 332 further comprising a corresponding joining means 322, said upper parallel section 333 and said lower parallel section 333 being separated by a distance substantially equal to that between the feet 121 of the sidewall 120 present this embodiment. The trapping space 331 may further comprise a replaceable surface 334 configured such that the replaceable surface 334 and insect-trapping adhesive may be replaced without removing the flexible wrapping material 300 from the targeted tree. Other means of joining the feet 121 to the flexible wrapping material 300 may be apparent to one skilled in the art upon review of this disclosure and are intended to be included within the scope of the claims herein. A method of deploying this embodiment of the invention comprises the method of deploying the preferred embodiment as set forth above, and further comprises the step of deploying the length of flexible wrap 300 to encircle the targeted tree prior to the steps of fixing the first and subsequent links 100 to the targeted tree; further, a step of placing the links 100 in this alternative method further comprises joining the joining means 122 on the feet 121 of each sidewall 120 to the corresponding joining means 322 on the flexible wrapping material.

Alternate embodiments of the flexible wrapping material 300 may incorporate a rough inner surface to increase friction between the cloth and the tree. Yet further alternate embodiments of the flexible wrapping material 300 may further comprise attachments for fasteners such as nails which may be fixed to the targeted tree. Further still, additional alternate embodiments of the flexible wrapping material 300 may further incorporate at least three layers 310 further comprising at least two outer layers 311 and at least one inner layer 312; said outer layers 311 may comprise weather-resistant fabric as disclosed, and said inner layers may comprise compressible fabric or foam which may be compressed or otherwise deformed during the installation of the links 100 as disclosed in the methods herein to form a more complete barrier on the targeted tree. All embodiments of the flexible wrapping material 300 may be configured at varying lengths to join into a ring encircling the targeted tree by the described means; it is preferred that each end of the flexible wrapping material 300 be designed to overlap at least several inches, preferably more, in order that the same flexible wrapping material 300 may be deployed to different targeted trees of varying diameters. An embodiment of the flexible wrapping material 300 may be designed according a set length to join at a matching pair of distal ends to encircle the targeted tree. Yet further embodiments of the flexible wrapping material 300 may be configured to be readily cut to size in order to form a ring in which the ends have only a desired length of overlapping material.

All embodiments of this flexible wrapping material 300 incorporate the trapping space 331 configured to accept insect-trapping adhesive as previously disclosed. The flexible wrapping material 300 may be useful for the trapping of insects without the chain 200, but in such an embodiment cannot prevent by-catch; consequently, all claimed and disclosed embodiments or deployment methods comprising the flexible wrapping material 300 are configured to accept deployment of one or more embodiments of the chain 200 as disclosed herein. No claim is made to any embodiment of the flexible wrapping material 300 not so configured, nor is any claim made to any method of using the flexible wrapping material 300 without use of the links 100 or chain 200 described herein.

One or more links 100 in the chain 200 may be configured in embodiments not in conformity with other links 100. Identical links 100 are not required in the chain 200; one link 100 may comprise or omit elements and adornments according to the decisions of the user. A chain 200 comprising links 100 of disparate joinable or abuttable embodiments of the sidewalls 120 or opposite edges 113 may be deployed, such that each link 100 may only be deployed to join with or abut against a pair of designated matching links 100.

The minimalist design and configuration of the present invention permits various additional elements and adornments to be added according to the needs of each user; reduction of the present invention in its preferred embodiment to the robust, unadorned, 3D-printable link 100 described herein permits the incorporation of such adornments in ways not possible for the prior art. The modular design further allows the links 100 to be designed as sturdy, inflexible pieces, whether or resin or other materials, which can better withstand such modification by users in contrast to prior art comprising flexible, unitary pieces. In embodiments comprising such modifications, one or more links 100 may be configured to accept one or more scented or colored baits to attract targeted species of insects, to comprise one or more ribbons to deter approach by birds, or electronic devices for monitoring the rate of capture of insects. Yet further embodiments may incorporate one or more nets for the live capture of insects, preferably omitting insect-trapping adhesive in such configurations. Other elements and adornments known in the art may be adapted for use with the present invention by one skilled in the art. Such adornments may preferably be fixed to a selected link; the selected link 100 may be configured to joint with or abut with a pair of matching links 100, restricting deployment of the link 100 comprising said adornment to a particular portion of the chain 200.

Any number of links 100 in the chain 200 may be replaced with nonconforming links 100 joinable to or abuttable to other links 100. Additional configurations of links 100 and nonconforming links 100 forming variants of the chain 200 will be apparent to one skilled in the art in light of the disclosure set forth herein; it is intended that such configurations are included in the scope of the claims set forth herein.

Additional embodiments may be apparent to one skilled in the art in light of this disclosure. This disclosure is intended to incorporate those additional embodiments. The embodiments set forth herein are intended to be illustrative and not exhaustive and should not be seen as imposing additional limitations on the claims.

What is claimed is:

1. A modular insect barrier device comprising:
A plurality of links, each of said links further comprising:
An outer shell, at least one sidewall, and an endcap, the at least one sidewall being fixed to a first edge of the outer shell and the endcap being fixed to an adjacent edge of the outer shell, such that a volume of space is partially enclosed, and such that an entryway is located opposite to the endcap;
In which each of the plurality of links are abuttable to at least one other link of the plurality of links;
Such that all of the links comprising the plurality of links may be abutted to form a chain of a desired length;
In which the chain is configured to encircle a targeted tree.

2. The modular insect barrier device of claim 1, in which abuttable links are instead joinable links;

3. The modular insect barrier device of claim 1, in which an opposite edge of the outer shell is positioned opposite the at least one sidewall, configured such that the opposite edge of a first of the plurality of links is abuttable to the sidewall of a second of the plurality of links.

4. The modular insect barrier device of claim 3, in which the opposite edge of a first of the plurality of links is joinable to the sidewall of a second of the plurality of links.

5. The modular insect barrier device of claim 1, in which an insect-trapping adhesive is situated between the modular insect barrier device and the targeted tree, such that the insect-trapping adhesive is accessible through the entryway.

6. The modular insect barrier device of claim 5, in which the entryway is configured to deter access by animals larger than a targeted animal species.

7. The modular insect barrier device of claim 1, in which the at least one sidewall comprises two sidewalls, each of said two sidewalls of a first of the plurality of links being configured to be abuttable to or joinable to a second of the plurality of links.

8. The modular insect barrier device of claim 1, in which one or more of the links further comprises at least one cutout.

9. The modular insect barrier device of claim 1, further comprising a flexible wrapping material, being configured to be fixed to and completely encircle a selected section of a targeted tree, said flexible wrapping material comprising:
A length of one or more layers of fabric;
In which an outer surface of the flexible wrapping material further comprises at least three parallel sections;
The upmost and lowermost of said parallel sections further comprising a joining means configured to accept the plurality of links; and
An inner parallel section comprises a trapping space configured to accept the insect-capturing adhesive;
In which said flexible wrapping material is further configured to accept the modular insect barrier device over the outer surface.

10. The modular insect barrier device and flexible wrap of claim 9, in which the flexible wrap comprises at least three layers, the inner layer being comprised of a flexible foam.

11. A method for deploying the insect barrier device of claim 1, the method comprising the steps of:
A user selects a number of the plurality of links sufficient to encircle a targeted tree;
The user fixes each of the selected links to the targeted tree in a configuration such that the links abut one another and such that the endcaps and entryways of each links are all substantially parallel to those of each other link and such that an inner-facing surface of the outer shell of the links is oriented toward the targeted tree.

12. The method of claim 11, in which at least two of the plurality of links are configured to further comprise at least two joinable elements, the method further comprising the step of the user fixing joinable elements of each link to corresponding joinable elements.

13. The method of claim 12, further comprising the step of the user joining two or more of the selected links to form a chain prior to the step of fixing said links to the targeted tree, but in any event for this step at least one joinable element of the chain must remain unjoined prior to encircling the tree.

14. The method of claim 11, further comprising the step of placing the chain to encircle the targeted tree such that the chain substantially covers an insect-trapping adhesive.

15. The modular insect barrier device of claim 1, further comprising as a separate component a flexible wrapping material, said flexible wrapping material comprising:
A length of one or more layers of flexible material;
An outer surface of the flexible wrapping material further comprising:
At least three parallel sections lengthwise relative to the length of the one or more layers of flexible material, the uppermost and lowermost of said parallel sections further comprising a joining means configured to accept the plurality of links, the center parallel section being configured to accept insect-trapping adhesive;
In which each of the plurality of links is further configured such that the at least one sidewall of each of said links further comprises at least two of a joining means, said joining means being separated by a distance substantially the same as that between the uppermost and lowermost of the parallel sections of the flexible wrapping materials and being configured to join with the joining means of the flexible wrapping material.

16. The modular insect barrier device and flexible wrapping material of claim 15, in which the flexible wrapping material further comprises a corresponding attachment means configured to affix the flexible wrapping material to a targeted tree.

17. A method for deploying the modular insect barrier device and flexible wrapping material of claim 14, further comprising the steps of:
A user places the flexible wrapping material to encircle a targeted tree;
A user selects a number of the plurality of links sufficient to encircle the targeted tree over the flexible wrapping material;
The user fixes each of the selected links to flexible wrapping material in a configuration such that each links abuts another, and such that the endcaps and entryways of each links are all substantially parallel to those of each other link and such that an inner-facing surface of the outer shell of the links is oriented toward the targeted tree;
Continuing the previous step until a final of the plurality of selected links is fixed to the first of the plurality of selected links to form a chain encircling the flexible wrapping material about the targeted tree.

18. The method as set forth in claim 17, in which at least two of the plurality of links are configured to further comprise at least two joinable elements, the method further comprising the step of the user fixing the joinable elements of each of the selected plurality of links to corresponding joinable elements of the next of the selected plurality of links.

19. The method of claim 18, further comprising the step of the user joining two or more of the selected links to form a chain prior to the step of fixing said links to the targeted tree, but in any event for this step at least one joinable element of the chain must remain unjoined prior to encircling the tree.
